(19) United States
(12) Patent Application Publication
(10) Pub. No.: US 2003/0134028 A1
(43) Pub. Date: Jul. 17, 2003

(54) Fat based food products

(75) Inventor: Lourus Cornelis Lievense, Vlaardingen (NL)

Correspondence Address: UNILEVER, PATENT DEPARTMENT, 45 RIVER ROAD, EDGEWATER, NJ, 07020, US

(73) Assignee: Lipton, Division of Conopco, Inc.

(21) Appl. No.: 10/372,743

(22) Filed: Feb. 24, 2003

Related U.S. Application Data
(63) Continuation of application No. 08/973,328, filed on Dec. 1, 1997.
Application No. 08/973,328 is a 371 of international application No. PCT/EP96/02344, filed on May 31, 1996.

(30) Foreign Application Priority Data
Jun. 1, 1995 (EP) 95201444.7
Jul. 25, 1995 (EP) 95202042.8

(51) Int. Cl. A23D 7/00

(52) U.S. Cl. 426/601

(57) ABSTRACT

The invention concers a fat based food product comprising natural fat components which have a blood cholesterol lowering effect in amounts sufficient to obtain a blood cholesterol lowering effect if the food product is used accroding to the common needs and customs of the consumer, wherein at least one of toctrienol, oryzanol and phytosterol is present, and preferably at least two and in a further preferred embodiment at least 0.1 wt % of tocotrienol, 0.1 wt % of oryzanol and 0.4 wt % of phytosterol. In a further preferred embodiment the fat in the product comprises at least 30 wt %, preferably at least 45 wt % of pufa-triglycerides. By the regular consumption of the now found fat based food products a positive contribution to health in general, and in particular to the lowering of the blood cholesterol level can be found.

The present invention concerns a fat based food product comprising natural fat components which have a blood cholesterol lowering effect in amounts sufficient to obtain a blood cholesterol lowering effect if the food product is used according to the common needs of the consumer.

Such fat based food products are available on the market for quite some time, and are to a large extend based on the use of fat which comprises a particular amount of triacylglycerides with poly-unsaturated fatty acid chains. In particular, the use of butter like spreads comprising a significant amount of these triacylglycerides having polyunsaturated fatty acid chains (hereinafter called pufatriglycerides) is well known in the western world to reduce high blood cholesterol levels.

The variation in the mean plasma total cholesterol concentration among populations is highly correlated with the variation in the extent of atherosclerosis and in the incidence of Coronary Heart Disease (CHD), which is one of the major causes of death in the Western society. Populations with a low cholesterol level (less than 180 mg/dl (4.7 mmol/L) are found to be largely free of atherosclerosis and coronary heart disease, whereas those with mean cholesterol levels above 220 mg/dl (5.7 mmol/L; hypercholesterolaemia) have increased rates of death due to CHD. Thus, a clear need for a method by which the cholesterol level can be lowered exists.

With the common products which comprise pufa-triglycerides, a particular amount of fat should be eaten on a daily bases to ensure a high enough intake of these triglycerides. A contribution of a minimal intake of pufa-triglycerides of 3 to 4 percent of the metabolizable energy is recommended. However, if fat based food products are used in which part of the fat is dispensed with, for example by the use of thickeners and/or fat replacers, products with a very low fat level such as low fat spreads comprising less than 20% fat would have a less blood cholesterol lowering effect than a product comprising 80% fat, given that a similar amount of pufa-triglycerides is present in the fat.

For this type of products, a need for further improvement of the cholesterol lowering effect in fat based food products exists. Also for fat based food products which up till now did not comprise pufa-triglycerides, the presence of components which have a cholesterol lowering effect is desired.

As consumers these days have a clear preference for food products which are obtained from natural sources our invention deals with food products which contribute to the health of consumers by the use of ingredients obtained from natural vegetable, oil related sources and to include such particular natural ingredients in their context, i.e. in food products comprising ingredients similar to the source of the particular ingredients. In the context of vegetable oil and fat based products, we have now found that some particular natural non-triglyceride minor oil components can be used in food products which are used on a daily basis, and which have a possible contribution to health in general, and in particular to the lowering of blood cholesterol level.

It has now been found that a significant lowering of blood cholesterol level is obtainable by the regular consumption of fat based food products which comprise at least one compound of the group consisting of tocotrienol, phytosterol, and oryzanol, in an amount of at least 0.2 wt % for tocotrienol, at least 1 wt % for phytosterol and at least 0.25 wt % for oryzanol or their relative amounts if mixtures of one or more of these components are used, the weight percentages being based on the total weight of the fat based food product.

For economical reasons, amounts between 0.2 and 4 wt %, 1 and 20 wt % and 0.25 and 6 wt % respectively will be sufficient for these ingredients to obtain a cholesterol lowering effect. Of course, higher amounts can be applied if so desired.

Preferably, the fat based food product of the present invention comprises at least one compound of the group consisting of tocotrienol, phytosterol, and oryzanol, in an amount of 0.5-1.5 wt % for tocotrienol, 2-8 wt % for phytosterol, and 0.5-2.5 wt % for oryzanol or their relative amounts if mixtures of one or more of these components are used, the weight percentages being based on the total weight of the fat based food product. In an more preferred embodiment the fat based food product comprises at least 0.8 wt % tocotrienol or at least 4 wt % phytosterol or at least 1.2 wt % oryzanol or a combination of two or more thereof in their relative weights.

Tocotrienol, phytosterol, and oryzanol are hereinafter also referred to as ‘healthy components’.

The fat based food products of the present invention comprise preferably more than one compound of the group consisting of tocotrienol, phytosterol, and oryzanol. In this case, the amount of the single components can be less than those indicated hereinabove, as long as care is taken that for the compound, a relative same weight amount of the other compounds is used. Thus, if tocotrienol is applied alone, at least 0.2 wt % should be present. This amount can be indicated as the minimum effective dose (MED). For phytosterol, the minimum effective dose is 1 wt %, for oryzanol 0.25 wt %. If a lower amount of one or more of these components is used, e.g. 60% of the MED of one of the components is used, a total of 40% of the sum of the MED of the other components should be present as well.

For example, if tocotrienol and phytosterol are present, an amount of the tocotrienol, e.g. 50% thereof, can be replaced by phytosterol, of which then also at least 50% of its effective minimum dose amount should be applied. In the case of this example, the fat based food product should comprise at least 0.1 wt % tocotrienol and at least 0.5 wt % phytosterol.

The amounts are amounts normally being sufficient to obtain statistically significant effects after use of these products in amounts similar to the amounts of the prior art fat based products, and for a prolonged period of time.

These amounts are based on common daily intake of the fat based food products. If more or less of such products are being used according to the particular use in a particular area or habits, the amounts can be adapted accordingly.

Tocotrienol, phytosterol, and oryzanol are compounds which are known per se, and these are known to have a positive effect on health for different reasons.

Japanese patent laid open number 04/320,645 describes the use of unsaponified substances of rice bran oil in rice bran oil, and mentions that the oil exhibited a very good physiological action. No substantiation of this is given. In the present application, by the use of these components not only a cholesterol lowering effect, but also some antioxidative working can be found.

In a specific embodiment of the present invention, also at least one of tocopherol and polyphenol is present. These components are known as such, and have been described in different publications. For example, in “Tocopherole—Antioxidantien der Natur; by Pongracz et al.; Fat Sci. Technol.; 97. Jahrgang Nr. 3, pp. 90-104” a study of the use of tocopherols as antixoxidants in, inter alia, food is described.

The use of at least one of tocotrienol and oryzanol is preferred, these components showing an effect on blood cholesterol even stronger than phytosterol. A further preference exists for a fat based food product which comprises at least 0.1 wt % tocotrienol, 0.1 wt % oryzanol and 0.4 wt % phytosterol.

Applicants have strong indications that the use of these healthy minor oil components results in a blood cholesterol lowering stronger than obtainable by the use of any pufa-triglyceride fat blend.

As a further improvement of fat based food products comprising one of these components, it was found that the use of a mixture of these healthy ingredients shows an effect on health, in particular blood cholesterol lowering, which is much stronger than the effect which can be expected on the basis of the studies published regarding the effect of cholesterol lowering per weight amount of intake of each of these components alone. Moreover, this synergy was not found for blood cholesterol lowering alone, but also on other health aspects. In particular, such combinations of oryzanol, tocotrienol and phytosterols show a very beneficial effect which could not be expected on the basis of the published health effect of these compounds alone.

The oil related components used in the fat based foods of the present invention can be found as minor components in most plants from which oil is recovered. As conventional oil milling aims at producing triacylglycerols with a minimum amount of unsaponifiable matter, only limited amounts or none of the non-triglyceride healthy components at all are found in the oil presently available. The components to be used in the products of the present invention are found in the waste product streams which results upon the refining processes for obtaining commonly, classically refined oils. As only very minor amounts of the suitable components are found in the waste streams of the usual oil refinings, e.g. sunflower oil, soybean oil, rapeseed oil, maizgerm oil and the like, using the waste of commonly used seed material will require enormous amounts of the waste material to be further process. However, relative significant amounts of one or more of these components can be found in materials not always used (yet) on a large scale as an fat or oil source. In particular, the components very suitable for the present invention can be found in, for example, rice bran (in particular oryzanol, phytosterols, and also tocopherols), wheat and maize germ (in particular phytosterols and tocotrienols), oat and oat bran in particular phytosterols and tocotrienols), sesame seed (in particular phytosterols), soybean, sheanuts (phytosterol). The healthy minor oil components can also found, although in amounts lower than the sources mentioned before, in, for example, sunflower, rape, palm, olive, line, peanuts, cotton, safflower and lignin.

Tocopherol and polyphenol can also be obtained from most of these natural vegetable, oil related sources. These components can additionally be present where reference is made to ‘healthy components’.

The healthy components can be added as single, pure components, as a mixture of such single, pure components, as components present in a concentrate obtained from specific processing of the natural source, as components obtained by mixing such concentrates (e.g., obtained from different sources) and the like.

The mixtures of the healthy oil components can be prepared by mixing single, pure components (bought at specialized suppliers) or be obtained by treating the oils and oil containing raw materials in such a way that the minor components remain therein. By specific processing, concentrates comprising a high amount of healthy minor oil components can be obtained. These are applied by preference if the ‘naturalness’ of a product is considered a particular issue. The concentration of the healthy minor oil components should be such that, if the concentrate is applied, the amounts indicated before are present in the fat based food product. Consequently, this means that the concentration should be high if it is desired to make a product in which the fat is replaced by non-fat ingredients, and a large amount of the other ingredients in the concentrate are fatty components.

Fat based food products are food products (partially) based on fat and regarded by the user, in particular the consumer, as ‘fatty type of products’. Examples are yellow fat spreads, dressings, coffeecreamer, shortenings, cooking and frying oils, fillings and toppings, and the like. These products in most cases comprise a particular amount of fat. In some cases, however, products are still regarded as ‘fatty type of products’, despite a replacement of part or even all the fat by fat replacers. Fat based food products in which the fat is partially or completely replaced by fat replacers are also covered by the term fat based food products of this invention.

Fat products consisting of fat only are also considered as fat based food products in this specification. These are not only used as cooking and frying oils, but also sometimes in the industry in the preparation of food products, e.g. in baking.

The food products as such are common products in the western world, and are used by consumers on a daily basis in amounts different for each individual.

The invention is in particular very suitable for yellow fat spreads, dressings, cheese, shortenings and cooking and frying oils, and more in particular for yellow fat spreads which can comprise 0 (zero) to 90% fat (usually 5-80%). Dressings can comprise 0 to 85% fatty (usually 5-80%). Shortenings, cooking and frying oil more than 95% fat.

In a highly preferred embodiment, the food product is a yellow fat spread comprising 0 to 40% fat, preferably 0 to 25% fat, the product comprising at least one of tocotrienol, phytosterol, and oryzanol, in an amount of at least 0.4 wt % for tocotrienol, at least 2 wt % for phytosterol, and at least 0.5 wt % for oryzanol or their relative amounts if mixtures of one or more of these components are used, the weight percentages being based on the total weight of the fat based food product.

Yellow fat spreads comprising less than 25 wt % fat, and at least 0.5 wt % tocotrienol and 1.2 wt % oryzanol can be regarded as very beneficial in that these not only have a very low fat content, but also show an antioxidative effect and a significant lowering of the blood cholesterol working if applied similar to a common butterlike spread on a regular, daily basis.

The use of the minor healthy components in cheese shows an additional beneficial effect, which is that the cholesterol in cheese is adsorbed by the body in a far lesser amount if phytosterol is present in the cheese than without. Hence, whereas cheese consumption usually adds cholesterol to the body, with the use of healthy minor oil components, in particular phytosterol, a strongly reduced absorbtion and a blood cholesterol lowering effect will be found. This effect can also be found for food products other than cheese comprising cholesterol or consumption of cholesterol containing food products in combination with the products as described in the invention.

The fat that is applied in these fat based food products can be any fat, such as dairy fat and/or vegetable fat. However, if fat is present, for health reasons the use of one or more vegetable fat sources is preferred. In particular, the use of liquid fats is preferred. These can be hydrogenated, interesterified, and the like. The fat can be one single fat or a blend. The fat or one of the fats applied can also beneficially be obtained from the same source as the healthy components are obtained from. E.g., rice bran oil can be obtained and mixed with one or more of the healthy components mentioned in this description which also are obtained from rice bran, or a mixture of sesame oil and rice bran oil can be used with one or more health components obtained from sesame seed and/or rice bran.

The use of fat compositions comprising a considerable amount of pufa-triglycerides in addition to the use of the healthy components is in particular considered highly beneficial. For example, oils of sunflower, safflower, rapeseed, linseed, linola and/or soybean can be used in a preferred embodiment. Also the fat compositions mentioned in Netherlands patent documents no. Nl 143115, NL 178559, NL 155436, NL: 149687, NL 155177, European patent documents EP 41303, EP 209176, EP 249282, and EP 470658 are highly suitable.

If a fat blend is used, it is preferred that it comprises at least 30%, and more preferred at least 45% of poly-unsaturated fatty acids, based on the total weight amount of the fat in the fat based food product. So, a strong effect on the cholesterol lowering effect is obtained if use is made of a mixture of healthy minor oil components such as tocopherol, tocotrienol, phytosterol, oryzanol and polyphenol or extracts comprising these components, in a food product in which a fat blend comprising at least 30 wt. % of pufatriglycerides is used.

In another embodiment of the invention, it has been found that using specific technologies to incorporate the components in the food product significantly increased their physiological beneficial activity. In addition thereto, the solubility of the healty components in the food product will increase, and, as a result thereof, the maximum concentration can be increased without altering the product characteristics and quality.

The technigues which can be applied beneficially are incorporation into the fat by the use of micro-emulsions, liposomes, incorporation into micro-particles or adhering to micro-particles. According to another method, one or more of the healthy components that might show a low solubility is esterified as desired with one or more fatty acids to increase their solubility. In the intestine these esters will be hydrolysed resulting in the free fatty acids and active minor oil component.

1. Fat based food product comprising natural fat components which have a blood cholesterol lowering effect in amounts sufficient to obtain a blood cholesterol lowering effect, wherein the fat comprises at least one compound of the group consisting of tocotrienol, phytosterol, and oryzanol in an amount of at least 0.2 wt % for tocotrienol, at least 1 wt % for phytosterol, and at least 0.25 wt % for oryzanol, or their relative amounts if mixtures of one or more of these components are used, the weight percentages being based on the total weight of the fat based food product.

2. Fat based food product according to claim 1, wherein the fat comprises at least one compound of the group consisting of tocotrienol, phytosterol, and oryzanol in an amount of 0.5-1.5 wt % for tocotrienol, 2-8 wt % for phytosterol, 0.5-2.5 wt % for oryzanol or their relative amounts if mixtures of one or more of these components are used, the weight percentages being based on the total weight of the fat based food product.

3. Fat based food product according to any one of claim 1 or 2, wherein the food product comprises at least two of tocotrienol, phytosterol, and oryzanol, and preferably at least 0.1 wt % of tocotrienol, 0.1 wt % of oryzanol and 0.4 wt % of phytosterol.

4. Fat based food product according to any one of claims 13, wherein the food product is prepared by use of a concentrate comprising at least one of tocotrienol, phytosterol and/or oryzanol obtained by the specific processing of an oil and/or oil containing raw material.

5. Fat based food product according to any one of claims 14, wherein the fat used in the product is a fat comprising at least 30 wt %, and preferably at least 45 wt % of pufatriglycerides, calculated on the total weight of the fat present in the product.

6. Yellow fat spread comprising 0 to 40% fat, preferably 0 to 25% fat, the product comprising at least one of tocotrienol, phytosterol, and oryzanol, in an amount of at least 0.4 wt % for tocotrienol, at least 2 wt % for phytosterol, and at least 0.5 wt % for oryzanol or their relative amounts if mixtures of one or more of these components are used, the weight percentages being based on the total weight of the fat based food product.

7. Yellow fat spread according to claim 6, wherein the yellow fat spreads comprises less than 25 wt % fat, and at least 0.5 wt % tocotrienol and 1.2 wt % oryzanol.

8. Fat based food product according to any one of claims 1-5, wherein at least one of tocopherol, tocotrienol, phytosterol, oryzanol and polyphenol, is incorporated into the fat by the use of micro-emulsions, liposomes, incorporation into micro-particles or adhering to micro-particles.

9. Use of an oil concentrate comprising more than 5 wt % of one or more of tocopherol oryzanol and phytosteral for the preparation of a fat based food product according to any one of claims 1-6.

10. Use of an oil concentrate comprising more than 5 wt % of one or more of tocopherol oryzanol and phytosteral for the preparation of a yellow fat spread according to any one of claims 7-8.
